(19) United States
(12) Patent Application Publication
(10) Pub. No.: US 2007/0042159 A1
(43) Pub. Date: Feb. 22, 2007

(54) Elastic floor mat

(76) Inventors: Minoru Sugihara, Shimane (JP); Noboru Sugihara, Shimane (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/553,197

(22) PCT Filed: Apr. 27, 2004
(86) PCT No.: PCT/JP04/06097

§ 371 Date: Oct. 13, 2005

(30) Foreign Application Priority Data
Apr. 28, 2003 (JP) 2003-123863

(51) Int. Cl. B32B 3/00

(52) U.S. Cl. 428/156; 428/58

(57) ABSTRACT

A floor mat laid on a floor surface, constructed from a sheet-like or plate-like member with a predetermined thickness. The mat has relatively hard edge portions (4) at both ends in its width direction, and the edge portions (4) are formed as inclined surfaces gradually descending in a predetermined width to the outer edges of the mat. A belt-like central portion with a predetermined width is provided inside the edge portions (4), and the central portion is formed as an elastic portion that has a uniform thickness or height corresponding to the thickness of inner ends of the edge portions (4) and is softer in elasticity than the edge portions (4). In another example, the mat has a support mat (1) and a belt-like elastic mat (2). A receiving portion (3) is formed between the edge portions (4) of the support mat (1), in the front face side or back face side of the support mat. The elastic mat (2) is received in the receiving portion (3), serving as an elastic portion. In still another example, an elastic portion (2′) can be constituted of a space portion (3′) and a large number of projections (33). The space portion (3′) is formed as an upward recess with a predetermined depth formed in the installation surface side of the mat. The projections (33) are projected downward in the space portion (3′) and their lower end surfaces are in elastically contact with the floor surface.

### TECHNICAL FIELD

This invention relates to an elastic floor mat having recognition and discrimination functions being adaptable to guide mainly the visually disabled (inclusive of blind and weak-sighted persons, for instance) in walking.

### BACKGROUND ART

As a means that is generally taken to guide the visually disabled in walking, embossed blocks and/or tiles as shown in FIG. 4 contained in Japanese Patent Laid-open No. 2002-250016 are used in laying arrangement for passageways in station precincts and buildings for public use. The above embossed blocks and/or tiles are available in types in which square or rectangular blocks having, on the surfaces, uneven portions being helpful in guiding walkers are laid in an embedded state on or fixedly mounted to a passageway floor surface.

However, the embossed blocks etc. described the above endanger the visually disabled and/or the physically handicapped owing to the presence of the uneven portions and/or a difference in level etc. on the surfaces of the embossed blocks. Specifically, the visually disabled and/or the physically handicapped are exposed to danger of stumbling over the uneven portions and/or the difference in level etc. and falling in the course of walking, or of slipping on the wet or frozen surface and falling in rainy weather and/or snowfall seasons etc.

In addition, use of the embossed blocks in hospitals and facilities etc. for the physically handicapped gives rise to the following problems on the occasion of traveling of wheelchairs and transfer beds etc. Specifically, the presence of the uneven portions and/or the difference in level etc. on the surfaces of the blocks etc. hinders straight traveling, and imparts vibrations to patients etc. to a large extent to apply a considerable burden to or endanger the patients etc. Thus, at present, the use of the embossed blocks is forbidden within the hospitals etc.

Besides, each embossed block is of a structure having a certain thickness. Thus, when the embossed blocks are newly installed on the existing floor, it is necessary to cut a portion matching an embossed block size from an existing floor material before laying the embossed blocks in the embedded state by fitting the blocks into a cutout portion of the floor material. Thus, works of cutting the floor surface and of laying the embossed blocks in the embedded state require time and labor, resulting in an increase in cost.

Alternatively, as shown in FIG. 2 contained in Japanese Patent Laid-open No. 2000-70108, a mat that is to protect workers in working fields and/or kitchens etc. mainly involving works in standing position and/or with walking actions against fatigues and/or troubles etc. of one's legs and loins is well known.

However, while this mat is effective in preventing the workers from the fatigues and/or troubles of one's legs and loins, it requires a complicated structure and thus provides disadvantages of being not only costly and heavyweight but also inconvenient to handle.

To solve the problems with the above related arts, an object of the present invention is to provide an elastic floor mat that is capable of surely guiding the visually disabled etc. by smoothing a difference in level between the mat and a floor surface.

Further, the present invention aims at attaining the following objects.

(1) To not only prevent walkers from stumbling and falling, but also suppress vibrations generated in the course of traveling of the wheelchairs and the transfer beds by means of forming upper surfaces of edge portions at both ends of the mat into the shape of gradually descending inclined surfaces so as to smooth a difference in level between the floor surface and the mat.

(2) To surely guide the visually disabled in coming to the parting and/or corner etc. of the passageways by means of making a difference in elasticity between an elastic mat and a support mat so as to permit the visually disabled to be aware of a change in feel of one's foot on the ground and/or in touch of one's walking stick in the course of walking.

(3) To surely hold a hardly fixative elastic mat in predetermined position by means of fixing the support mat to a bottom surface, with the elastic mat held by the support mat. In addition to the above, to prevent damages of the elastic mat by means of receiving and holding the elastic mat in the support mat.

(4) To prevent joint portions from making the difference in level, while strengthening the joint portions by means of overlapping, in misalignment into the form of staggered layers, the positions of joint ends of the support mats and the elastic mats or surface sheets of mutually adjacent two mats.

(5) To attain an object of surely guiding the visually disabled etc. by means of, with the elastic portion composed of a grounding surface-side space portion in the form of an upward recess portion having a predetermined depth and a large number of projections contained in downwardly projecting arrangement in the space portion, giving to the walkers etc. an impression of difference between touch with the edge portions and that with the elastic portion and also with the existing floor surface so as to permit the visually disabled etc. to be aware of the change in feel of one's foot on the ground and/or in touch or sound of one's white walking stick etc.

(6) To prevent misalignment of the mat by means of forming grounding surfaces of the projections into the shape of upwardly curbed recess-like suction surfaces so as to give a function as a suction board for a smooth floor surface to the mat for enhancement of fixedness of the mat to the floor surface.

(7) To enhance the fixedness in connection of the mutually adjacent mats by means of forming, at front and rear ends of the elastic portion of the mat, end wall portions into the shape of indented portions ensuring that the end portions of the mutually adjacent mats are fitted to each other in mutual engagement.

(8) To ensure that a laying work is executable without applying a work of digging the floor even to a case where it is necessary to lay the mat on the existing floor surface. Further, to ensure that fixing of the mat to the existing floor surface by bonding using a double-sided adhesive tape is applicable to the laying work, thereby making contribution toward realization of a mat that is easily repairable and replaceable.

(9) To apply treatment for non-slip to the surface sheet or the mat surface so as to prevent the walkers from stumbling and falling.

(10) To ensure that electromagnetic guiding and metal detection guiding etc. to a mobile- or portable-type transmitter/receiver and/or a wheelchair equipped with the above transmitter/receiver etc. is executable by means of embedding a metal guideline (a guide portion) longitudinally in the mat, and besides, use of the metal guideline as an electric wave transmitting antenna is also practicable in the case of emergency etc.

### DISCLOSURE OF THE INVENTION

To attain the above objects, a device of the present invention relates to a mat that is made up of a sheet- or plate-like member having a predetermined thickness and is laid on a floor surface. According to a first feature of the present invention, the mat has widthwise left- and right-side upper surfaces being in the form of relatively hard edge portions 4 having inclined surfaces gradually descending in a predetermined width toward the outer edges of the mat, and a belt-like central portion having a predetermined width forms, at the inner side of the edge portions 4, an elastic portion having a uniform thickness or height corresponding to the thickness of inner ends of the edge portions 4 and being softer in elasticity than the edge portions 4.

According to a second feature of the present invention, the mat has a support mat 1 having, at the surface or back surface side between the edge portions 4 at the opposite sides, a receiving portion 3 being in the form of a belt-like recess portion, and a belt-like elastic mat 2 received in the receiving portion 3, and the elastic mat 2 forms the elastic portion.

According to a third feature of the present invention, the support mat 1 has, at the back surface side, the receiving portion 3, wherein the support mat 1 is made up of a transparent or semi-transparent member, and has, between the elastic mat 2 received in the receiving portion 3 and the support mat 1, a display portion 10 capable of being seen through the surface side.

According to a fourth feature of the present invention, the elastic mat is fixed to the inside of the receiving portion 3 by bonding.

According to a fifth feature of the present invention, a structure of connecting, for extensible arrangement, a plurality of elastic floor mats together at front and rear ends specified as longitudinal ends is employed, provided that joints of joint portions of the support mats 1 and the elastic mats 2 are located in misalignment by a predetermined size into the form of staggered layers not to overlap each other as viewed in plan.

According to a sixth feature of the present invention, in a mat that is made up of a sheet- or plate-like member having a predetermined thickness and is laid on a floor surface, the mat has widthwise left- and right-side upper surfaces being in the form of relatively hard edge portions 4 having inclined surfaces gradually descending in a predetermined width toward the outer edges of the mat, a belt-like center portion having a predetermined width forms, at the inner side of the edge portions 4, an elastic portion 2′ having a uniform thickness or height corresponding to the thickness of inner ends of the edge portions 4 and being softer in elasticity than the edge portions 4, and the elastic portion 2′ is composed of an installation surface-side space portion 3′ being in the form of an upward recess portion having a predetermined depth, and a large number of projections 33 contained in downwardly projecting arrangement in the space portion 3′ and having lower end surfaces in elastically contact with the floor surface.

According to a seventh feature of the present invention, circumference surfaces of the projections 33 are in the form of tapered or curbed surfaces so as to be tapered toward the grounding surface side.

According to an eighth feature of the present invention, the grounding surfaces of the projections 33 are in the form of upwardly curbed recess-like suction surfaces 34.

According to a ninth feature of the present invention, the mat has, at one or both of the front and rear ends of the elastic portion 2′, end wall portions 36 being equal in height to the projections 33, and the end wall portions 36 are in the form of indented portions ensuring that the end portions of the mats laid in mutually adjacent arrangement are fitted to each other in mutual engagement.

According to a tenth feature of the present invention, the upper surface of at least one of the front and rear ends of the elastic floor mat is in the form of an end edge portion 12 having a gradually descending inclined surface.

According to an eleventh feature of the present invention, the elastic floor mat has, on the surface exposed to the outside, a non-slip 5 being in the form of a surface having minute irregularities.

According to a twelfth feature of the present invention, the elastic floor mat is applicable as a floor guide mat that has, at the surface or installation surface side or in a section, a guide portion 11 adaptable to guide the walkers or users inclusive of wheelchair users by taking advantage of electromagnetic or magnetic force in relation to a direction of forward stepping.

### BRIEF DESCRIPTION OF THE DRAWINGS

FIG. 1 is a perspective view generally showing a structure of a mat according to the present invention;

FIG. 2 is a transverse sectional view showing an inside structure of the mat;

FIG. 3 is an enlarged transverse sectional view showing an inside structure of an edge portion of the mat;

FIG. 4 is a longitudinal sectional view showing a connection state of the mat;

FIG. 5 is a longitudinal sectional view showing a different connection state of the mat;

FIG. 6A is a plan view showing an L-shaped crossing of a crossing member of the mat;

FIG. 6B is a plan view showing a cross-shaped crossing of the crossing member of the mat;

FIG. 6C is a plan view showing a T-shaped crossing of the crossing member of the mat;

FIG. 7 is a plan view generally showing one installation state of the mat;

FIG. 8 is a perspective view generally showing a second embodiment of the mat;

FIG. 9 is an enlarged cross-sectional view showing the second embodiment of the mat;

FIG. 10 is an enlarged cross-sectional view showing a joint portion of the mat in the second embodiment according to the present invention;

FIG. 11 is a plan view showing a different embodiment of a crossing portion of the mat;

FIG. 12 is a perspective view showing a third embodiment of the mat according to the present invention;

FIG. 13A is a plan view showing one shape of an end support mat in the third embodiment;

FIG. 13B is a plan view showing a different shape of the end support mat in the third embodiment;

FIG. 14 is a perspective view generally showing a fourth embodiment of the mat according to the present invention;

FIG. 15 is a perspective view showing the back surface of the mat in the fourth embodiment according to the present invention;

FIG. 16 is a cross-sectional view taken along a line A-A in FIG. 14;

FIG. 17 is a cross-sectional view taken along a line B-B in FIG. 14; and

FIG. 18 is a plan view showing one installation of the crossing portion of the mat in the fourth embodiment according to the present invention.

### BEST MODE FOR CARRYING OUT THE INVENTION

First to fourth embodiments of an elastic floor mat according to the present invention are now described with reference to the accompanying drawings.

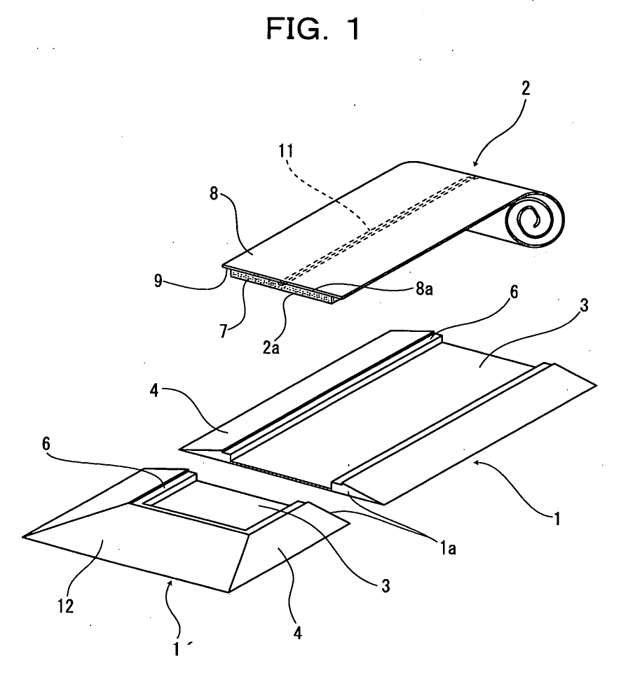

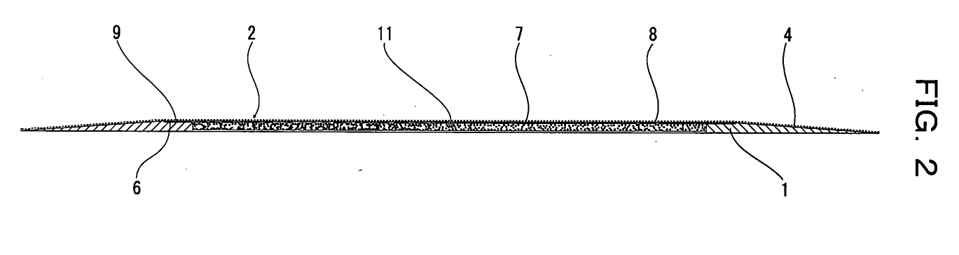

FIGS. 1 to 7 show the first embodiment of the present invention. FIGS. 1 and 2 are a perspective view and a cross-sectional view respectively showing a finished configuration of the mat according to the present invention. The mat in the first embodiment shown in FIGS. 1 to 7 has a support mat 1 and an elastic mat 2 that is, after being fitted into the support mat 1, bonded all over the elastic mat surface to the support mat surface overlapping with the elastic mat surface. The elastic mat 2 received in the support mat 1 forms an elastic portion.

The support mat 1 has, at the surface side in the center, a U-groove-like receiving portion 3, and at left- and right-side ends, edge portions 4. The edge portions 4 have respectively surfaces that take the form of inclined surfaces descending to outer edges in order to smooth a difference in level between the mat and a floor surface. For instance, the edge portions 4 having an inclination angle in the range of about 2 to 15° are applied to the first embodiment. In addition, the inclined surfaces of the edge portions do not always necessary to be of a flat shape, and alternatively, may be those each having a rounded circular-arc-shaped section. Further, the receiving portion 3 has, at the opposite ends, stepped portions 6 in the form of a difference in level, and the stepped portions are adapted to be fixed, by bonding, to selvage portions 9 of a surface sheet 8 described later.

The elastic mat 2 is composed of a belt-like cushion material 7 made up of a synthetic resin-made foaming or hollow material and the surface sheet 8 fixed to an upper surface of the cushion material 7 by bonding. Then, the elastic mat is supposed to be bonded all over the elastic mat surface, after being received in the receiving portion 3 with the elastic mat prevented from its movement.

The surface sheet 8 is formed with a rubber- or synthetic resin-made sheet etc., and treatment for non-slip 5 is applied to the surface of the surface sheet by bonding sandy substances etc. consisting of an inorganic material etc. to the surface of the surface sheet. The above non-slip 5 may be that obtained by forming irregularities for non-slip on the surface of the surface sheet 8 or by bonding a separate non-slip sheet (not shown) to the surface of the surface sheet. In addition, the surface sheet 8 has, at the opposite side ends, the selvage portions 9 projecting from the opposite side ends of the cushion material 7.

Further, the mat has an embedded linear or tape-shaped metal guideline (a guide portion) 11 adapted to guide a mobile- or portable-type transmitter/receiver and/or a wheelchair equipped with the above transmitter/receiver etc. In FIG. 1, there is shown the guideline 11 that is embedded within sections of the cushion material 7 and the surface sheet 8 of the elastic mat 2. It is noted that the guideline 11 may be that embedded within a section of the support mat 1 or between overlapping surfaces of the support mat 1 and the elastic mat 2, or alternatively, that fixedly mounted to either of the surface and the back surface of the mat.

As shown in FIG. 1, an end support mat 1′ is connected to a terminating- or starting-point end of the support mat 1. The end support mat 1′ is in the form of a U-shaped mat such that the receiving portion 3 and the stepped portion 6 of the end support mat have respectively closed ends. An end edge portion 12 has a surface that takes the form of an inclined surface descending in an oblique direction to the terminating- or starting-point end, like the edge portions 4 described the above.

Use of the above configurations permits the support mat 1 and the end support mat 1′ to adapt the edge portions 4 and the end edge portions 12 to smoothing of the difference in level between the mat and the floor surface at the time of laying. It is noted that the selvage portion 9 corresponding to a U-shaped stepped portion 6 at the inside of the end support mat 1′ is also formed with the surface sheet 8 at each of the terminating- and starting-point ends of the elastic mat 2.

In execution of a laying work, after fixing of the support mat 1 of a relatively small-sized unit length to a predetermined position of a floor etc. by bonding using a double-sided adhesive tape etc., fitting of the cushion material 7 into the receiving portion 3 takes place to fix the cushion material to the receiving portion by bonding, while unwinding the elastic mat 2 having been so configured as to be capable of being unwound after being wound into a roll. Then, fitting of the selvage portions 9 to the surfaces of the stepped portions 6 follows, and is followed by fixing of the support mat 1 to the elastic mat 2 by bonding not to make the difference in level between the joint portions of the support mat 1 and the elastic mat 2. Bonding is executable by applying the adhesive to the overlapping surfaces of the support mat and the elastic mat or by interposing the double-sided adhesive tape (not shown) between the above overlapping surfaces.

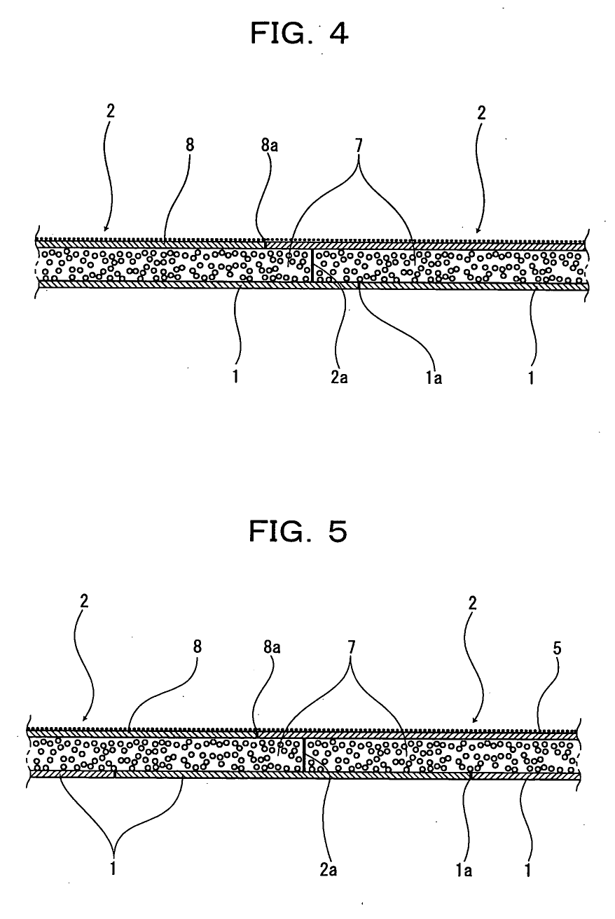

The joint portion in a longitudinal direction is now described. When a joint end 1a of the support mat 1 and a joint end 2a of the elastic mat 2 are at the same position (See FIG. 4), the joint ends 1a of the support mats 1 are fixed by bonding in a face-to-face butted state, and the elastic mats 2 are bonded to the upper surface of the support mats 1. In this case, the upper surface of the joint end la of one support mat 1 and the bottom surface of the elastic mat 2 of the other adjacent support mat overlap each other. Also, the elastic mats 2 are connected together such that the bottom surface of the surface sheet 8 of one elastic mat 2 and the upper surface of the other elastic mat overlap each other. Then, the overlapping surfaces and the face-to-face butted surfaces of the support mats and the elastic mats are fixed by bonding in misalignment of positions not to overlap each other at the same position as viewed from the side. Use of the above structure provides the advantage of permitting the elastic mats 2, that is, the mats to be connected in the longitudinal direction without making the difference in level between the mats, and also of holding a connection strength of the joint portions. Reference numeral 8a denotes a joint end of the surface sheet 8.

Further, connection in the manner similar to that as described the above is also applicable to the case where the joint end of the support mat 1 and the joint end of the elastic mat 2 are at different positions (See FIG. 5), except that positions of the joint end 1a of the support mat 1 and the joint end 2a of the elastic mat 2 are different from those described the above.

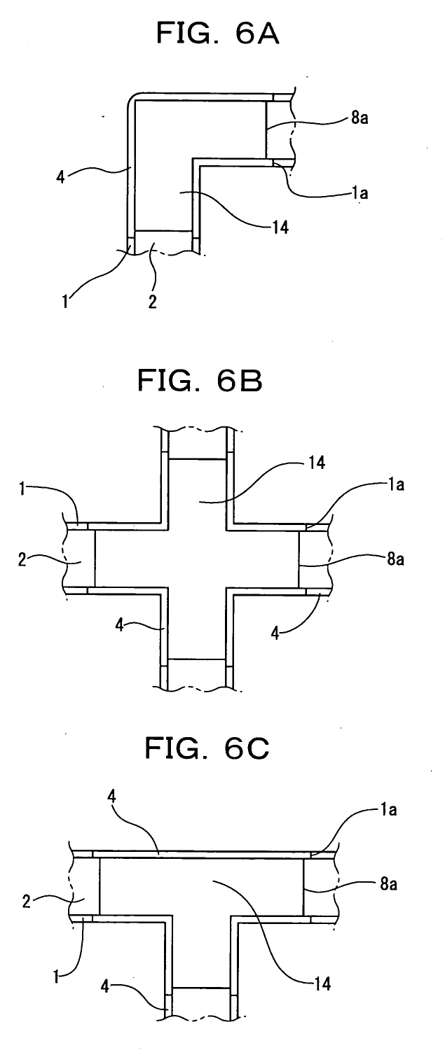

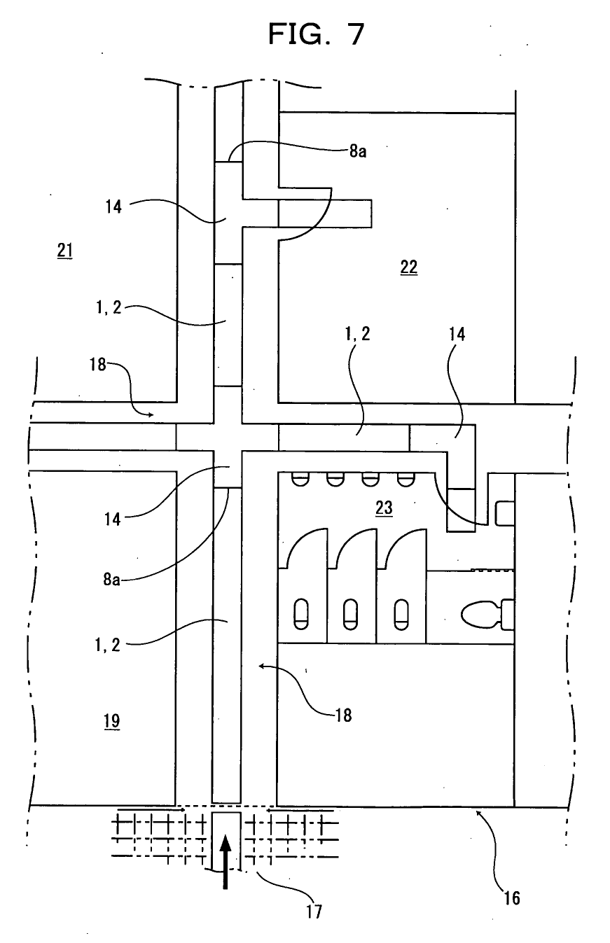

It is necessary for the crossing to preliminarily manufacture crossing members 14 partly contained in the guide mat as shown in FIGS. 6A to 6C, specifically, the crossing members for L-shaped crossing in FIG. 6A, cross-shaped crossing in FIG. 6B and T-shaped crossing in FIG. 6C. Installation of the elastic floor mat of the present invention takes place by connecting the support mats 1 and the elastic mats 2 according to the above connection method using the crossing members as appropriately required for each crossing (See FIG. 7). It is, however, noted that connection of the crossing members 14 to the support mats 1 and the elastic mats 2 takes place in the same manner as applied to the case where the joint end of the support mat 1 and the joint end of the elastic mat 2 are at the same position (See FIG. 4). Further, the preliminarily manufactured crossing members 14 are used, so that the resultant crossings are not limited to the above crossings, and it is also allowable to form different types of crossings such as a trifurcated passageway.

FIG. 7 shows one laying of the guide mat of the present invention when applied to an indoor facility. In the above one laying, it is assumed that there is provided a passageway (or hallway) 18 extending from an entrance 17 in a facility 16, and this facility contains rooms 19, 21, 22 and toilet facilities 23 that are all in the form of compartments abutting on the passageway 18. It is also assumed that the elastic floor mats of the present invention are fixed to by bonding, after being continuously laid on the center of the floor surface of the passageway 18.

The crossing members 14 are arranged at the respective crossings, and, in the above one laying, the elastic floor mats are laid so as to guide the walkers from the passageway 18 to the room 22 and the toilet facilities 23. Thus, the walkers inclusive of the visually disabled may be guided through the above elastic floor mats.

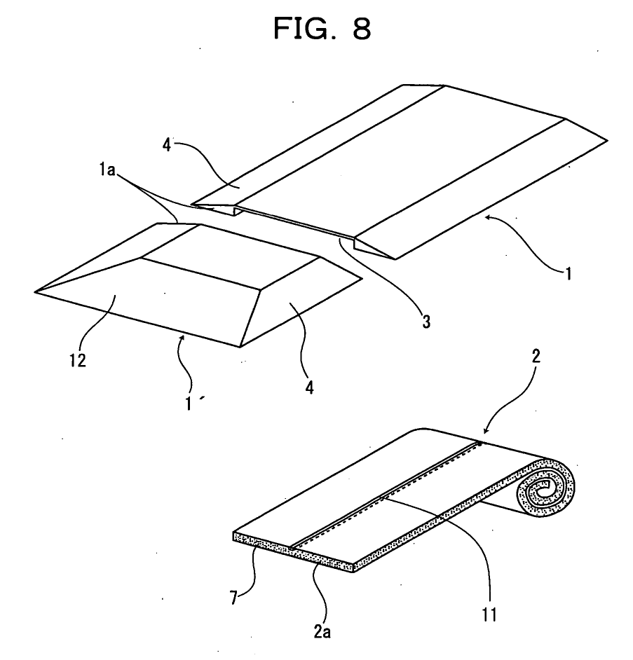

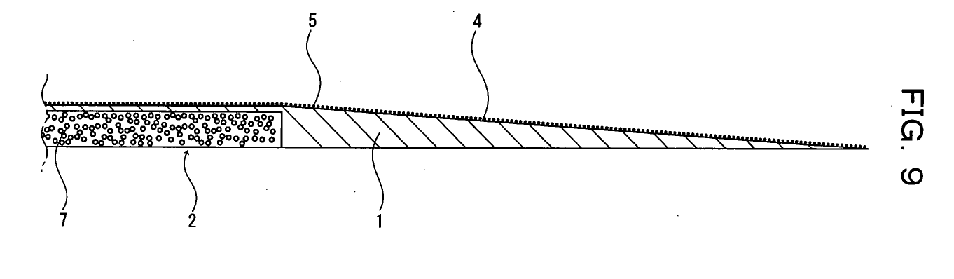

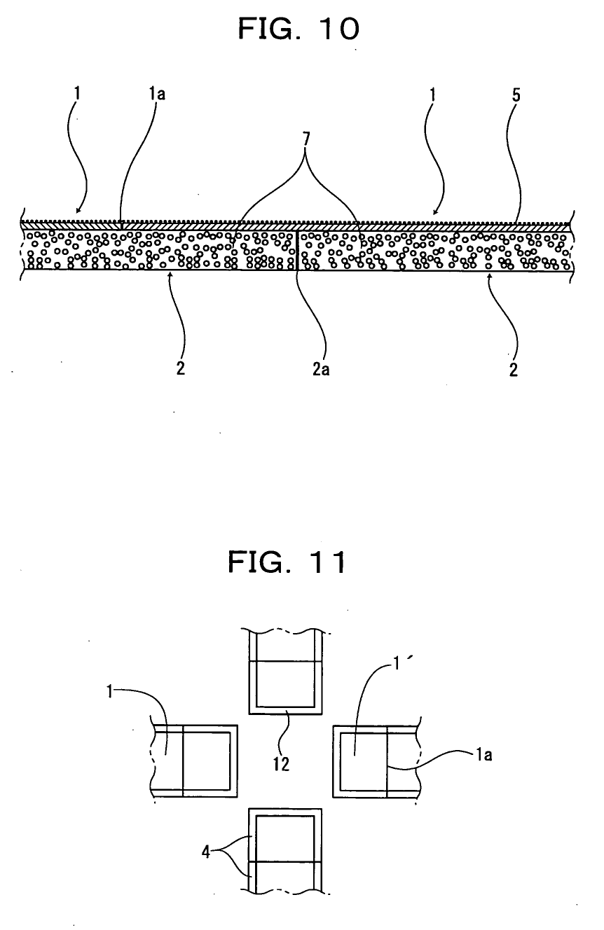

FIGS. 8 to 11 show a second embodiment of the present invention. Particularly, FIGS. 8 to 10 show the support mat 1 having, at a grounding surface side specified as the back side, the elastic mat receiving portion 3 being in the form of a U-groove-like portion. As a result, the elastic mat 2 is supposed to be received in the receiving portion 3 at the back surface side of the support mat 1. Thus, with the guide mat laid, the bottom surface of the elastic mat makes contact with the floor surface together with the bottom surfaces of the peripheral edge portions 4, 12, resulting in a state where the elastic mat is not exposed to the surface side.

Then, the surface side of the mat is all covered with the support mat 1. Like the previously described embodiment, the treatment for the non-slip 5 is also applied to the whole surface of the support mat by bonding the sandy substances consisting of the inorganic material to the whole surface of the support mat or by forming irregularities on the whole surface of the support mat 1 itself for bonding to the non-slip sheet etc. The second embodiment has configurations and functions other than the above in common with the first embodiment, and portions common to the first and second embodiments are illustrative with like reference numerals, so that a detailed description thereof is omitted.

Use of the configurations shown in FIGS. 8 to 10 provides the advantages of increasing durability of the elastic mat 2 involving use of a foaming plastic material etc., of being easy to apply the treatment for the non-slip 5 to the surface and so on

FIG. 11 shows a different embodiment of the crossing of the elastic floor mats, wherein formation of the crossing is finished using only the elastic mat 2-loaded end support mats 1′, instead of the crossing members 14 as shown in FIGS. 6A to 6C. In this embodiment, a portion where guide ways (the mats) cross each other forms a planar space with the floor surface exposed to the outside as it is. Thus, the visually disabled in the course of regular walking, for instance, may also become aware, by a difference between touch of one's walking white stick or one's foot with the elastic floor mat and that with the floor surface, that this is where the crossing lies. Accordingly, a more clear discrimination of the crossing from the other is attainable.

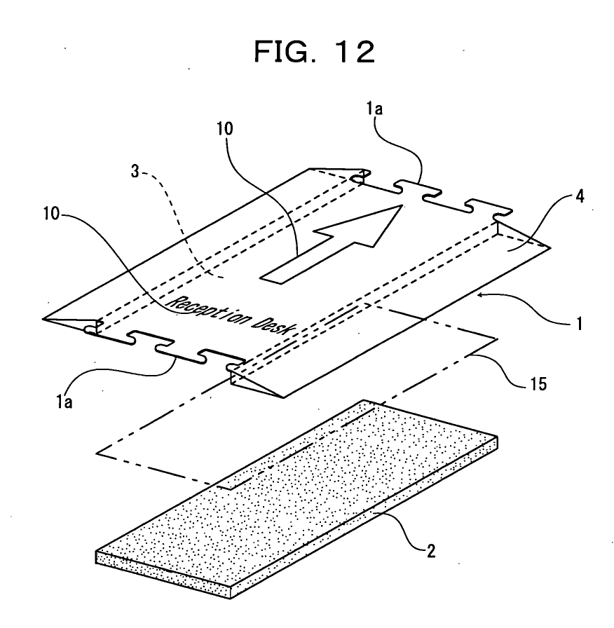

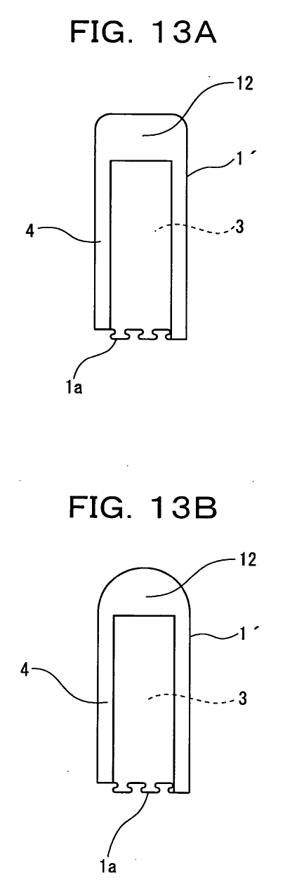

FIGS. 12, 13A and 13B show a third embodiment of the mat according to the present invention. The third embodiment is similar to the second embodiment shown in FIGS. 8 to 11 in that the support mat 1 has, at the grounding surface side, the receiving portion 3. However, unlike the second embodiment, the third embodiment has features that involves the support mat 1 made up of a transparent or semi-transparent plastic material, and also adopts a dovetail connection ensuring that the joint end la of one support mat 1 and the joint ends 1a of other adjacent support mats 1, 1a are connected in engagement with each other.

The support mat 1 made up of the transparent material is used, so that it is allowable to give, to the inside surface side of the receiving portion 3, display of information effectively available for sound walkers having no visual trouble by printing or interposition of a display portion (or a display tool) 10 such as characters of “Reception Desk” or arrows indicating locations or directions. Likewise, display of patterns (not shown) capable of being seen through the upper surface side is also executable. It may be expected that the display portion 10 provides higher effects by executing the display with fluorescent, reflective or persistent ink, paint or materials to ensure that visual recognition of the display portion is easily practicable even in the nighttime or under the insufficient illuminating environment.

Further, it is also allowable to contrive a ground color of the internally received elastic mat 2 or to effect coloring with patterns etc. given to the upper surface of the elastic mat. In addition to the above, with a sheet 15 interposed between the upper surface of the elastic mat 2 and the support mat, it is also allowable to give the above display portion 10 to the sheet 15 by printing or bonding, and besides, to use the colored sheet 15 as decorations for concealment of the ground color of the elastic mat 2 and so on.

FIGS. 13A and 13B respectively show the shapes of the end support mat 1′ connected to the mat shown in FIG. 12, and there is shown the end support mat whose end portion or corner portion at each of the opposite sides of the end portion is formed into the shape of a curbed portion. The third embodiment has features other than the above in common with the second embodiment shown in FIGS. 8 to 11, and portions common to the second and third embodiments are illustrative with like reference numerals.

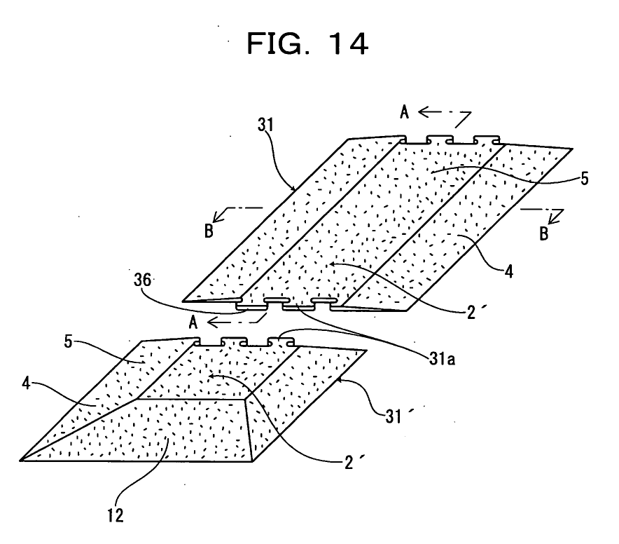

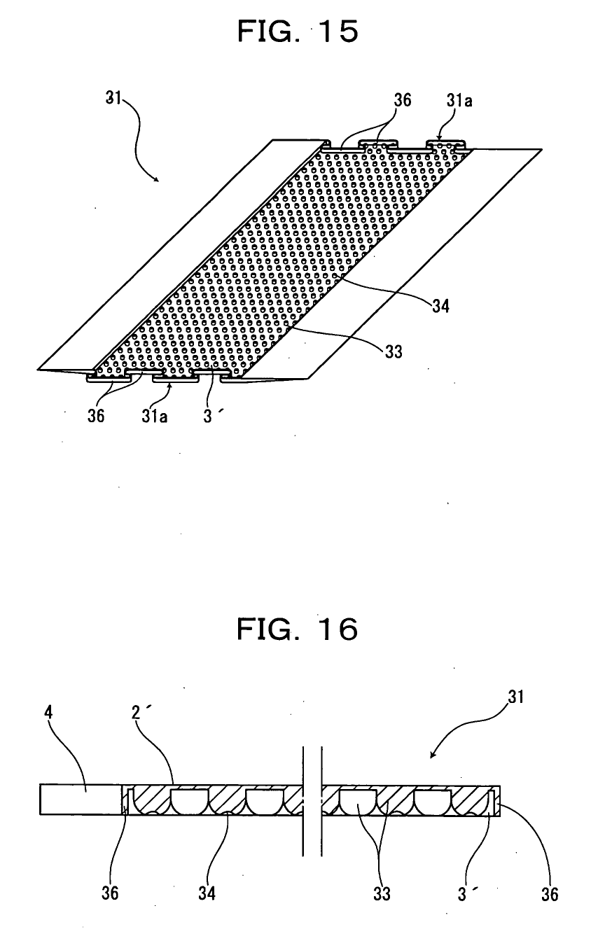

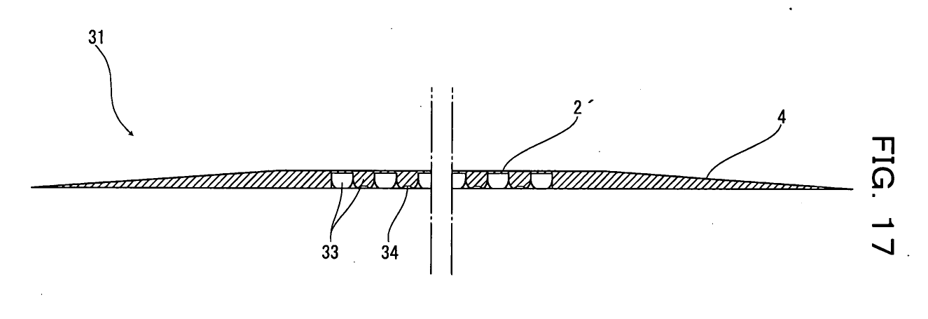

FIGS. 14 to 18 respectively show a fourth embodiment of the elastic floor mat. FIGS. 14 and 15 are respectively perspective views showing the surface and the back surface of the mat of the fourth embodiment, and FIGS. 16 and 17 are respectively cross-sectional views taken along lines A-A and B-B in FIG. 14.

The fourth embodiment is similar to the first to third embodiments in that a mat 31 of the fourth embodiment has, in the center, an elastic portion 2′ and, at the left- and right-side ends, the edge portions 4. However, the fourth embodiment has a feature that involves the elastic portion 2′ composed of a space portion 3′ and projections 33 as described later, instead of the elastic portion configured by receiving the elastic mat 2.

The elastic portion 2′ has, at the grounding surface side, the space portion 3′ being in the form of an upward recess portion having a predetermined depth, and the space portion 3′ has therein a large number projections 33 that are in downwardly projecting arrangement at uniform intervals. The lower end surfaces of the projections 33 are in elastically contact with the floor surface, thereby providing a configuration that gives elasticity to the elastic portion 2′.

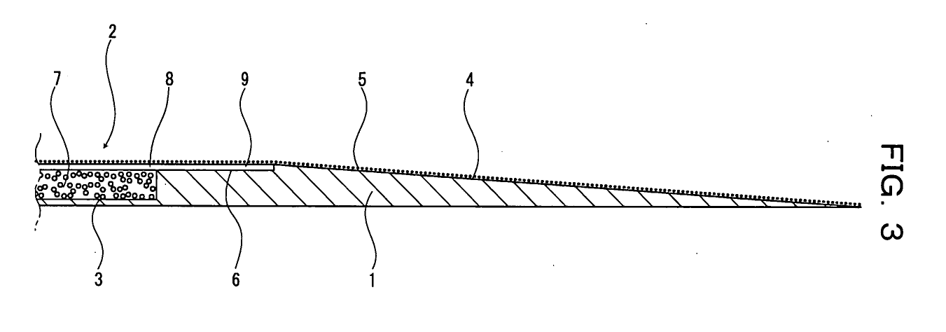

The projections 33 take the form of approximately cylindrical projections, and the circumference surfaces of the projections are in the form of tapered or quadratic-curved surfaces so as to be tapered toward the grounding surface side. The projections 33 have installation surface-side edge portions that are chamfered into the curbed shape. In addition, the grounding surfaces of the ends of the projections 33 are in the form of recess-like suction surfaces 34 as shown in the sectional views of FIGS. 3 and 4. Further, joint ends 31a of the mats 31, 31′ have end wall portions 36 each having a height equal to the thickness of the mat.

The fourth embodiment is similar to the above first to third embodiments in that the treatment for the non-slip 5 is applied to the edge portions 4 and the end edge portions 12 of the mat 31 and the end mat 31′ and to the surfaces of the mats 31. 31′. Further, the joint ends 31a of the mat 31, 31′ are the same as those in the third embodiment, and hence, a detailed description thereof is omitted.

In execution of the laying work, after fixing of only the mats 31 each having a relatively small-sized unit length to a predetermined position of a floor etc. by bonding, fitting of the joint ends 31a to each other in engagement takes place to connect the mats.

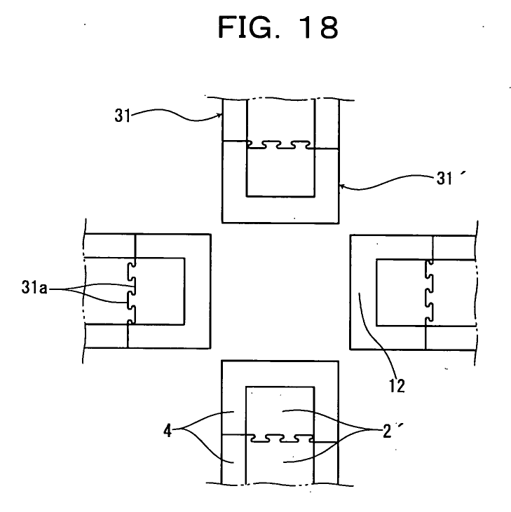

FIG. 18 shows one embodiment of the crossing of the guide ways involving use of the mats 31 and the end mats 31′, wherein the formation of the crossing is finished using only the mats 1 and the end mats 1′, instead of use of the preliminarily manufactured crossing members such as for cross-shaped, T-shaped, L-shaped and Y-shaped passageways. It is, however, noted that this crossing has the same configuration as the second embodiment shown in FIG. 11, and hence, a detailed description thereof is omitted.

### INDUSTRIAL APPLICABILITY

As has been described in the foregoing, the mat of the present invention is applicable not only as the guide mat for the walkers etc., but also as a cushioning mat laid on the position for working in standing position and/or a passageway floor surface for workers requiring works in standing position and/or with walking actions in various working fields, for instance. The mat applied as the cushioning mat is not limited in shape as viewed in plan to a rectangular mat, and may be also of a polygonal mat, in addition to a square or circular mat.

Further, the mat of the present invention is widely applicable as the non-slip etc. required for places around a swimming pool or in a large-scale bathroom, an airport and a station precinct, in addition to use not only as the guide way for the visually disabled etc. in walking but also as the display of information on destinations such as guiding to exits of buses and trains and indications of boarding positions at bus stops and platforms. Furthermore, the mat of the present invention may be also applied to the case of temporary laying of the mat on the conference or event grounds by means of only putting the mat on the floor without being bonded to the floor.

1. In a mat that is made up of a sheet- or plate-like member having a predetermined thickness and is laid on a floor surface, an elastic floor mat, characterized in that said mat has widthwise left- and right-side upper surfaces being in the form of relatively hard edge portions (4) having surfaces gradually descending in a predetermined width toward outer edges of the mat, and a belt-like central portion having a predetermined width forms, at the inner side of said edge portions (4), an elastic portion having a uniform thickness or height corresponding to the thickness of the inner ends of said edge portions (4) and also being softer in elasticity than said edge portions (4).

2. The elastic floor mat according to claim 1, wherein said mat has a support mat (1) having, at the surface or back surface side between the edge portions (4) at the opposite sides, a receiving portion (3) being in the form of a belt-like recess portion, and a belt-like elastic mat (2) received in said receiving portion (3), and said elastic mat (2) forms the elastic portion.

3. The elastic floor mat according to claim 2, wherein the support mat (1) has, at the back surface side, the receiving portion (3), in which case, said support mat (1) is made up of a transparent or semi-transparent member, and has, between the elastic mat (2) received in the receiving portion (3) and the support mat (1), a display portion (10) capable of being seen through the surface side.

4. The elastic floor mat according to claim 2, wherein the elastic mat (2) is fixed to the inside of the receiving portion (3) by bonding.

5. The elastic floor mat according to claim 2, wherein a structure of connecting, for extensible arrangement, a plurality of elastic floor mats together at the front and rear ends specified as longitudinal ends is employed, provided that joints of joint portions of the support mats (1) and the elastic mats (2) are located in misalignment by a predetermined size into the form of staggered layers not to overlap each other as viewed in plan.

6. In a mat that is made up of a sheet- or plate-like member having a predetermined thickness and is laid on a floor surface, an elastic floor mat characterized in that said mat has widthwise left- and right-side end upper surfaces being in the form of relatively hard edge portions (4) having inclined surfaces gradually descending in a predetermined width toward outer edges of the mat, a belt-like central portion having a predetermined width forms, at the inner side of said edge portions (4), an elastic portion (2′) having a uniform thickness or height corresponding to the thickness of inner ends of said edge portions (4) and being softer in elasticity than said edge portions (4), and said elastic portion (2′) is composed of an installation surface-side space portion (3′) being in the form of an upward recess portion having a predetermined depth, and a large number of projections (33) contained in downwardly projecting arrangement in said space portion (3′) and having lower surfaces in elastically contact with the floor surface.

7. The elastic floor mat according to claim 6, wherein circumference surfaces of said projections (33) are in the form of tapered or curbed surfaces so as to be tapered toward the grounding surface side.

8. The elastic floor mat according to claim 6, wherein the grounding surfaces of said projections (33) are in the form of upwardly curbed recess-like suction surfaces (34).

9. The elastic floor mat according to claim 6, wherein said mat has, at one or both of the front and rear ends of the elastic portion (2′), end wall portions (36) being equal in height with said projections (33), and said end wall portions (36) are in the form of indented portions ensuring that the ends of the mats laid in mutually adjacent arrangement are fitted to each other in mutual engagement.

10. The elastic floor mat according to claim 1, wherein the upper surface of at least one of the front and rear ends of the elastic floor mat is in the form of an end edge portion (12) having a gradually descending inclined surface.

11. The elastic floor mat according to claim 1, wherein the elastic floor mat has, on the surface exposed to the outside, non-slip (5) being in the form of a surface having minute irregularities.

12. The elastic floor mat according to claim 1, wherein the elastic floor mat is applicable as a floor guide mat that has, at the surface or installation surface side, or in a section, a guide portion (11) adaptable to guide walkers or users inclusive of wheelchair users by taking advantage of electromagnetic or magnetic force in relation to a direction of forward stepping.
